(19) United States
(12) Patent Application Publication
(10) Pub. No.: US 2024/0352607 A1
(43) Pub. Date: Oct. 24, 2024

(54) MULTILAYER COATINGS ON POROUS TRANSPORT LAYERS

(71) Applicant: ELECTRIC HYDROGEN CO., Natick, MA (US)

(72) Inventors: Dinesh SABARIRAJAN, Medford, MA (US); Timothy J. KUCHARSKI, Belmont, MA (US); Eduard NASYBULIN, Sudbury, MA (US); Nemanja DANILOVIC, El Sobrante, CA (US); Tenzin NANCHUNG, Somerville, MA (US); Erin CREEL, Framingham, MA (US)

(21) Appl. No.: 18/685,321

(22) PCT Filed: Dec. 27, 2022
(86) PCT No.: PCT/US2022/054085

§ 371 Date: Feb. 21, 2024

Related U.S. Application Data
(60) Provisional application No. 63/294,034, filed on Dec. 27, 2021.

(51) Int. Cl. C25B 13/07; C25B 11/065

(52) U.S. Cl. CPC C25B 13/07; C25B 11/065

(57) ABSTRACT

The following disclosure relates to electrochemical or electrolytic cells. fuel cells. and components thereof. More specifically. the following disclosure relates to applying an intermediate layer, coating layer, or sacrificial layer on a porous transport layer (PTL). A catalyst layer may be applied to the applied intermediate layer. The catalyst layer serves as both a protective passivation layer for the PTL and an oxygen evolution reaction electrocatalyst and the intermediate layer can have a portion removed.

The present patent document claims the benefit of U.S. Provisional Patent Application No. 63/294,034, filed Dec. 27, 2021, which is hereby incorporated by reference in its entirety.

### FIELD

The following disclosure relates to coating a porous transport layer.

### BACKGROUND

An electrochemical or electrolysis cell or system uses electrical energy to drive a chemical reaction. For example, within a water splitting electrolysis reaction within the electrolysis cell, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive installation of electrolyzer systems.

For example, in traditional electrolytic cell construction, nanoparticle catalysts may be used with an ionomer binder that is deposited onto a membrane. However, by depositing a nanoparticle catalyst layer on the membrane, pores may be blocked in a porous transport layer (PTL) and mass transport through the PTL may be reduced, thereby reducing cell performance. Further, applying the catalyst layer may introduce rips, tears, and local thinning of the membrane that create defects in the cell. Though thinner membranes may be used to increase performance of the cell, the reduced thickness makes such problems more prevalent.

Additionally, the cost of certain catalyst components within such catalyst layers are expensive. For instance, iridium is one of the most precious and low abundant materials on earth, yet various water electrolyzers use 1-2 mg/cm² of iridium oxide material. This loading level presents a cost prohibitive challenge for large scale production of water electrolyzers. The world's iridium production is roughly 3000-4000 kilograms per year. To solve this critical area of bottlenecking, research has focused on low loading catalyst and alternative catalyst materials. In some instances, lower catalyst loadings may involve deposition via spray methods, which may present challenges with unwanted effects such as accelerated degradation of the cell.

As such, there remains a need to provide an improved catalyst coating layer within an electrochemical cell.

### SUMMARY

In one embodiment, a method of preparing an electrolytic cell having a porous transport layer includes depositing an intermediate layer on the porous transport layer, depositing a catalyst layer on the intermediate layer, and removing a portion of the intermediate layer. The catalyst layer and a microporous structure remains on the porous transport layer.

In another embodiment, a method of preparing an electrolytic cell having a porous transport layer includes providing a porous transport layer and depositing a catalyst layer on a surface of the porous transport layer or a surface of a layer adjacent to the porous transport layer to provide a catalyst coated porous transport layer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrochemical or electrolytic cell.

FIG. 2 depicts an additional example of an electrochemical or electrolytic cell.

FIG. 3 depicts an example of a process of coating a porous transport layer.

FIG. 4 depicts an additional example of a method of coating a porous transport layer.

FIG. 5 depicts an additional example of a method of coating a porous transport layer.

FIG. 6 depicts an example of a coated porous transport layer and a membrane.

FIG. 7 depicts an example of vertically aligned carbon nanotube structures.

FIG. 8 depicts an example of aligned carbon nanotubes on a porous transport layer.

FIG. 9 depicts an example of a catalyst deposition on aligned nanotubes.

### DETAILED DESCRIPTION

The following discussion relates to methods, apparatus, and systems involved in the deposition of a catalyst layer onto a surface of a porous transport layer in place of deposition of the catalyst layer onto a surface of the adjacent membrane within the electrochemical cell. The disclosure describes different types of coatings deposited on porous transport layers that serve as both a protective passivation layer for the PTL and also as an oxygen evolution reaction electrocatalyst. The coatings may advantageously improve durability and cell performance. Examples of such processes, apparatus, and systems are described in greater detail below.

### Electrochemical Cells

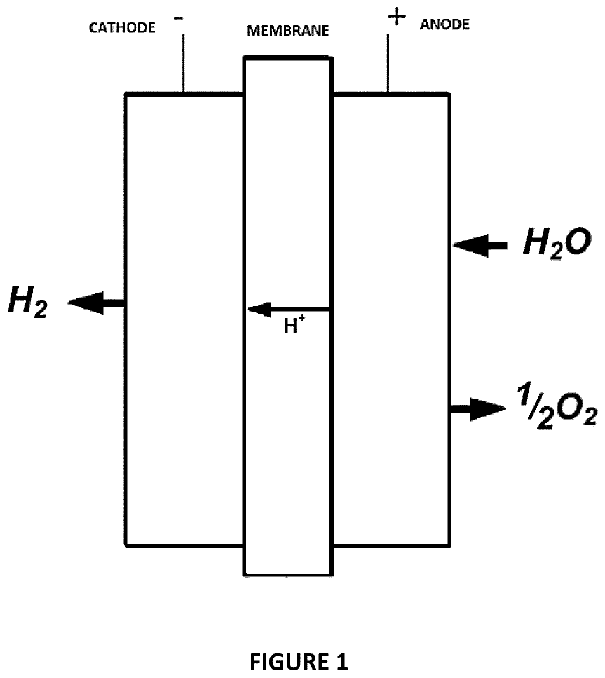

FIG. 1 depicts an example of an electrolytic cell for the production of hydrogen gas and oxygen gas through the splitting of water. The electrolytic cell includes a cathode, an anode, and a membrane positioned between the cathode and anode. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed great importance and renewed attention as a potential foundation for a decarbonized “hydrogen economy.”

Electrolytic cells may include additional components/layers positioned between the electrodes of the cell. For example, the cell may include a porous transport layer (PTL), or a gas diffusion layer positioned between an electrode (e.g., cathode or anode) and the membrane.

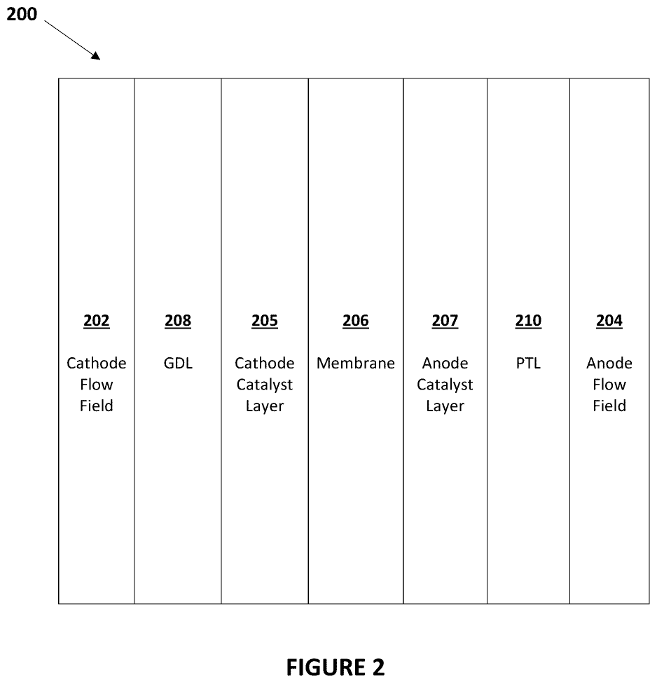

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204. In certain examples, the membrane 206 may have an overall thickness that is less than 1000 microns, 500 microns, 100 microns, 50 microns, 10 microns, etc.

In certain examples, additional layers may be present within the electrochemical cell 200. For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

In certain examples, the GDL is made from a carbon paper or woven carbon fabrics. The GDL is configured to allow the flow of hydrogen gas to pass through it. The thickness of the GDL may be within a range of 100-1000 microns, for example. As used herein, a “thickness” by which is film is characterized refers to the distance, or median measured distance, between the top and bottom faces of a film in a direction perpendicular to the plane of the film layer. As used herein, the top and bottom faces of a film refer to the sides of the film extending in a parallel direction of the plane of the film having the largest surface area.

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

In certain examples, the PTL is made from a titanium (Ti) mesh/felt. As used herein, a Ti mesh/felt may refer to a structure created from microporous Ti fibers. The Ti felt structure may be sintered together by fusing some of the fibers together. Ti felt may be made by a special laying process and a special ultra-high temperature vacuum sintering process. The Ti felt may have an excellent three-dimensional network, porous structure, high porosity, large surface area, uniform pore size distribution, special pressure, and corrosion resistance, and may be rolled and processed.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

The thickness of the PTL may be within a range of 100-1000 microns, for example. The thickness may affect the mass transport within the cell as well as the durability/deformability and electrical/thermal conductivity of the PTL. In other words, a thinner PTLs compared to thicker PTLs (e.g., 1 mm) may provide better mass transport. However, when the PTL is too thin (e.g., less than 100 microns), the PTL may suffer from poor two phase flow effects as well. PTLs are less prone to deformation compared to GDLs. Thickness of PTLs may also affect lateral electron conduction resistance along the lands in between channels.

In some examples, an anode catalyst coating layer may be positioned between the anode 204 and the PTL.

The cathode 202 and anode 204 of the cell may individually include a flow field plate composed of metal, carbon, or a composite material having a set of channels machined, stamped, or etched into the plate to allow fluids to flow inward toward the membrane or out of the cell.

### Deposition of Catalyst Layer on PTL

As discussed above, improved methods, apparatus, and systems related to electrochemical cells have been developed through the deposition of a catalyst coating onto a surface of the PTL instead of the surface of the adjacent membrane layer.

By depositing a catalyst on the PTL, issues associated with membrane catalyst deposition, such as blockage of pores in the PTL and limited mass transport through the PTL, may advantageously be avoided. Further, lower loading of catalyst may be achieved by using a conformal coating onto the porous transport layer, as opposed to traditional approaches that utilize nanoparticle catalysts in an ionomer binder that is deposited onto the membrane or transport layer to form a catalyst layer. The conformal coating on the PTL increases performance of the cell even at lower loading of the catalyst.

Additionally, because the catalyst is part of the PTL (e.g., deposited on the PTL, on an intermediate layer, or sacrificial layer), as opposed to traditional techniques of depositing the catalyst on the membrane in the cell, the PTL is less likely to degrade or cause any loss of integrity of the membrane. The reduced likelihood of membrane defects further reduces any prevalence of a hard or soft electrical short circuit occurring in the cell.

Still further, depositing a microporous layer on the PTL may create an improved interface between the catalyst layer and PTL, leading to improved electrochemical activity and lower mass transport losses in the cell. Improved interfaces, lower ohmic losses, improved reaction kinetics, lower mass transport, greater durability, and higher performance of the cell may be achieved by depositing both a catalyst layer and microporous layer on the PTL.

Coating a layer of catalyst on the PTL may be a useful alternative to conventional techniques because membranes, as they become thinner and thinner, are difficult to process. For example, the application of a conventional catalyst layer may introduce rips, tears, and local thinning of the membrane, causing defects in the cell. Hence, scaling up the process of manufacturing catalyst coated membranes without defects may be difficult.

Coating the PTL does not only protect the titanium surface at which the water splitting occurs, but also acts as an electrochemical catalyst. Metallic catalyst and metal oxide catalysts may be used with these approaches as both materials electrolyze water.

Coatings deposited on porous transport layers may advantageously serve as both a protective passivation layer for the PTL and also as an oxygen evolution reaction electrocatalyst. Further, the coatings may advantageously improve durability and cell performance.

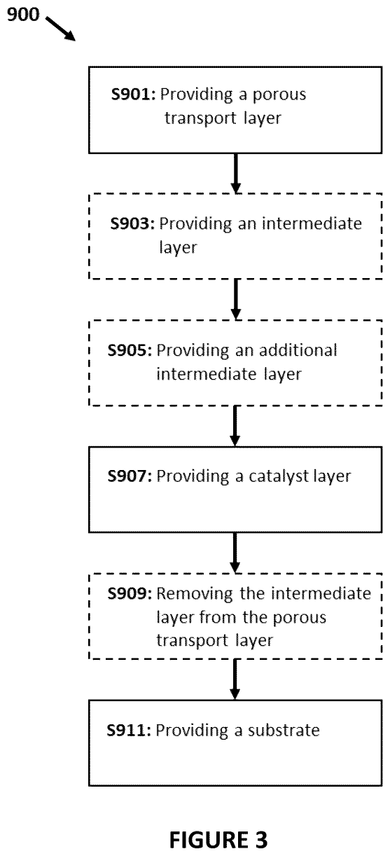

FIG. 3 depicts examples of processes of coating a porous transport layer (including various permutations with certain optional acts in the process). In act S901, the PTL is provided. In certain examples, the PTL includes a metal composition that is resistant to bending, cracking, and/or oxidation. In some examples, the PTL includes titanium.

In one example, the method proceeds directly to act S907, wherein a catalyst layer is deposited directly onto the surface of the PTL. The catalyst layer may be added using a variety of methods, such as nanomaterial slurry processing, solvent cast, tape casting, sputtering, electrodeposition, chemical vapor deposition (CVD), physical vapor deposition (PVD), or atomic layer deposition (ALD). The catalyst layer may include a catalyst configured to facilitate the oxygen evolution reaction on the anode side of the electrolytic cell. In some examples, the catalyst layer includes an iridium or iridium oxide (Ir/IrOx) catalyst. In other examples, the catalyst layer includes platinum. In yet other examples, the catalyst layer may include a combination of iridium or iridium oxide and platinum.

Though deposition, the catalyst layer advantageously covers and conforms to the porous structure of the PTL. This addition of catalyst may be advantageous in reducing the defects on the PTL that create a hard or soft electrical short in the cell, for example, caused by fibers of the PTL partially or entirely puncturing the membrane.

Following act S907, the method may proceed directly to act S911, wherein the catalyst coated PTL is adhered to the membrane such that the catalyst is positioned between the membrane and PTL. As noted above, this is advantageous in avoiding complications with catalyst deposition onto the membrane.

In other embodiments, the coating of the PTL may include one or more additional acts, such as those depicted in FIG. 3.

For example, prior to act S907, the surface of the PTL may be coated with one or more intermediate layers.

In act S903, an intermediate layer, sacrificial layer, or microporous layer may be applied to a surface of the PTL. The term “sacrificial layer” may be used for the intermediate or microporous layer because a later process may be used to remove portions of the intermediate layer. The composition of the intermediate layer advantageously retains the porosity of the PTL. The intermediate layer may be applied using techniques such as nanomaterial slurry processing, solvent cast, tape casting, sputtering, electrodeposition, chemical vapor deposition (CVD), physical vapor deposition (PVD), or atomic layer deposition (ALD). The addition of the intermediate layer may be advantageous in protecting various performance properties or physical characteristics of the PTL.

The intermediate layer may be applied to the PTL prior to catalyst deposition to optimize cell structure in plane (e.g., high planar area) and through plane (e.g., high 3D porosity). This may advantageously provide a conformal coating (e.g., covering the surface and the porous structure of the PTL) of Ir/IrOx or Pt via any deposition process.

In some cases, the intermediate layer may include a less noble element than the catalyst layer. The less noble element may be more reactive than the (e.g., Ir/IrOx) catalyst. For example, the less noble metal may be an alkali metal, an alkaline-earth metal, a rare earth element, or a transition metal such as Ni, Co, Fe, or Mn. In one example, the chosen less noble metal is not a noble or valve metal (e.g., Al, Ti, Ta, Nb). The less noble metal may be selected based on the size of the atom and miscibility in the Ir/IrOx matrix.

In another example, the intermediate layer deposited in act S903 may include carbon nanotube structures. The carbon nanotube structures may be configured to be vertically aligned (i.e., extending in a direction out from and perpendicular to the surface of the PTL). Advantageously, the carbon nanotubes may provide a high surface area support structure. The aligned carbon nanotube structures may be deposited or grown on the surface of the PTL via a chemical vapor deposition (CVD) process.

Depositing the carbon nanotube structures on the surface of the PTL as an intermediate layer advantageously allows the PTL to be used as an electrode for the oxygen evolution reaction within the electrochemical cell. Furthermore, the aligned carbon nanotube structures advantageously provide a high surface area. In some cases, the carbon nanotube structure or layer deposited on the surface of the PTL may increase the surface area by an order of 10³, 10⁴, 10^{5,} or 10⁶ times the surface area of the underlying PTL. This increased surface area advantageously may provide an improved catalyst deposition surface. In other words, the high surface area provided by the carbon nanotubes is advantageous because it will allow the use of very low catalyst loadings while maintaining or improved cell performance, therein enable low cost PEMWE.

The aligned carbon nanotube structures may have diameters in a range of 1-1000 nm, 1-100 nm, 10-500 nm, 20-200 nm, or 50-100 nm. Additionally, the length or height of the nanotubes may be in a range of 0.01-1000 microns, 0.1-100 microns, 1-100 microns, or 10-100 microns.

In certain examples, the process of coating the PTL with a catalyst coating layer may further include the optional act S905 of depositing or adding a second, additional intermediate layer onto the surface of the first intermediate layer. In certain examples, the additional intermediate layer may be made from a less noble element than the catalyst layer, such as those discussed above. The less noble element composition may be deposited on the first intermediate layer that may be a less noble element catalyst layer or a carbon nanotube layer, for example. Alternatively, the second, additional intermediate layer may be a carbon nanotube layer such as those discussed above. This second intermediate layer having carbon nanotubes may be deposited on the first intermediate layer having the less noble element as described above.

To the extent the method described in FIG. 3 includes the deposition of one or more intermediate layers, then, in act S907, the catalyst layer is added or deposited onto a surface of the exterior intermediate layer. As noted above, the catalyst layer may be added using a variety of methods, such as nanomaterial slurry processing, solvent cast, tape casting, sputtering, electrodeposition, CVD, PVD, or ALD. The catalyst layer may include a catalyst configured to facilitate the oxygen evolution reaction on the anode side of the electrolytic cell. In some examples, the catalyst layer includes an iridium or iridium oxide (Ir/IrOx) catalyst. In other examples, the catalyst layer includes platinum. In other examples, the catalyst layer includes both Ir/IrOx and platinum. By depositing the catalyst layer onto the intermediate layer, the intermediate layer advantageously protects the porous structure of the PTL from any effects of the deposition of the catalyst layer. Though deposition, the catalyst layer covers and conforms to the porous structure of the PTL as retained by the intermediate layer. This addition of catalyst may be advantageous in reducing the defects on the PTL that create a hard or soft electrical short in the cell, for example, caused by fibers of the PTL partially or entirely puncturing the membrane.

In optional act S909, the intermediate layer or one or more of the intermediate layers may be removed from the PTL, wherein the catalyst deposited on the intermediate layer remains present. In this case, the intermediate layer is a sacrificial layer that is temporarily present on the surface of the PTL to aid in the deposition of the catalyst layer. A microporous structure advantageously remains on the PTL after the intermediate layer has been removed.

The intermediate layer or layers may be removed through a variety of methods. In one example, the intermediate layer may be removed through chemical etching, e.g., with a solvent. The solvent may be any known solvent capable of dissolving the composition of the intermediate layer. Some known solvents used in etching processes include ferric chloride or nitric acid.

In one example, lithography may be used to specify the porous structure to be created by the etching. A lithographic mask may be deposited on the intermediate layer to control the etching and create the desired porosity. Removing the intermediate layer regains or reveals the porosity of the PTL and creates porous network of catalyst combined with PTL.

Additionally, or alternatively, heat may be applied to remove the intermediate layer.

In other examples, the intermediate layer may be removed over time by degradation. In other words, the intermediate layer may be left to decay or combust over time.

Following the optional removal of the intermediate layer(s), the method may proceed to act S911, wherein the catalyst coated PTL is adhered to the membrane such that the catalyst is positioned between the membrane and PTL. As noted above, this is advantageous in avoiding complications with catalyst deposition onto the membrane.

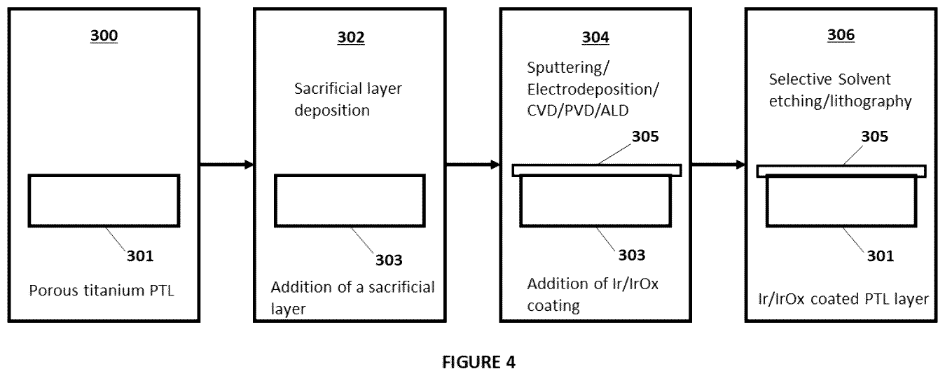

FIG. 4 depicts another example of a process of forming a catalyst coated PTL. In act 300, the PTL 301 is provided. In certain examples, the PTL 301 includes a metal composition that is resistant to bending, cracking, and/or oxidation. In some examples, the PTL 301 includes titanium.

In act 302, at least one intermediate or sacrificial layer 303 is applied to a surface of the PTL 301. As noted above, the intermediate layer 303 may be applied using techniques such as nanomaterial slurry processing, solvent cast, tape casting, sputtering, electrodeposition, chemical vapor deposition (CVD), physical vapor deposition (PVD), or atomic layer deposition (ALD). The addition of the intermediate layer 303 is advantageous in improving the subsequent catalyst deposition and protecting the porous structure of the PTL 301 from any effects of the deposition of the catalyst layer 305.

In some cases, the intermediate layer 303 may be made from a less noble element than the catalyst layer 305. The less noble element may be more reactive than the (e.g., Ir/IrOx) catalyst. For example, the less noble metal may be an alkali metal, an alkaline-earth metal, a rare earth element, or a transition metal such as Ni, Co, Fe, or Mn. In one example, the chosen less noble metal is not a noble or valve metal (e.g., Al, Ti, Ta, Nb). The less noble metal may be selected based on the size of the atom and miscibility in the Ir/IrOx matrix.

In another example, the intermediate layer 303 may include carbon nanotube structures.

In yet another example, the intermediate layer 303 may include a first intermediate layer of the less noble element as described above and a second intermediate layer of the carbon nanotubes may subsequently be deposited on the first intermediate layer.

In act 304, a catalyst layer 305 is added to the PTL 301 surface that has been covered with the intermediate layer 303. The catalyst layer 305 may be added using a variety of methods, such as nanomaterial slurry processing, solvent cast, tape casting, sputtering, electrodeposition, CVD, PVD, or ALD. The catalyst layer 305 may include a catalyst configured to facilitate the oxygen evolution reaction on the anode side of the electrolytic cell. In some examples, the catalyst includes an iridium or iridium oxide (Ir/IrOx) catalyst. In other examples, the catalyst includes platinum.

By depositing the catalyst layer 305 onto the intermediate layer 303, the intermediate layer 303 advantageously protects the porous structure of the PTL 301 from any effects of the deposition of the catalyst layer 305. Though deposition, the catalyst layer covers and conforms to the porous structure of the PTL 301 as retained by the intermediate layer 303. This addition of catalyst may be advantageous in reducing the defects on the PTL 301 that create a hard or soft electrical short in the cell, for example, caused by fibers of the PTL 301 partially or entirely puncturing the membrane.

In act 306, the intermediate layer 303 may be removed from the PTL 301. A microporous structure advantageously remains on the PTL 301 after the intermediate layer is removed. In certain examples, the intermediate layer is removed via etching (e.g., chemical etching such as with a solvent), which may advantageously selectively remove the intermediate layer 303 while leaving the catalyst layer 305 intact. In one example, lithography may be used in act 306 to specify the porous structure to be created by the etching. A lithographic mask may be deposited on the intermediate layer 303 to control the etching and create the desired porosity. Removing the intermediate layer 303 regains or reveals the porosity of the PTL 301 and creates porous network of catalyst combined with PTL 301.

In another example, in act 306, the intermediate layer 303 may be removed over time by degradation. In other words, the intermediate layer 303 may be left to decay, decompose, or combust over time. In some examples, a carbon nanotube intermediate layer may advantageously decompose over a period of time in oxygen without requiring any etching process. Advantageously, after decomposition, the carbon is removed but the deposited catalyst remains and retains the high surface area structure and its beneficial performance characteristics.

The resulting porosity of the PTL 301 may be controlled by use of a less noble metal in the intermediate layer 303. As part of the removal in act 306, the less noble element may be selectively etched/dissolved out (e.g., in addition to the intermediate layer 303) to create a porous catalyst layer that includes the retained catalyst (e.g., Ir/IrOx). The result is a catalyst layer 305 with better site access to more of the deposited Ir/IrOx material from increased surface area in comparison with a process of depositing a catalyst layer directly onto the PTL.

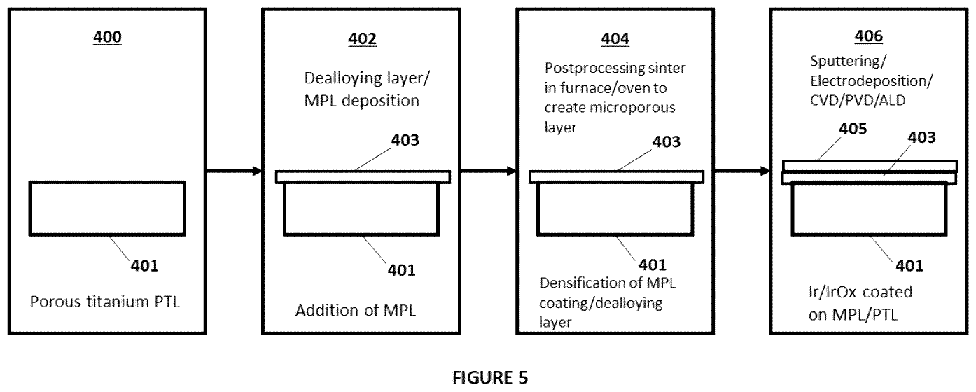

FIG. 5 depicts an additional example of a method of coating a porous transport layer. In act 400, the PTL 401 is provided. In certain examples, the PTL 401 includes a metal composition that is resistant to bending, cracking, and/or oxidation. In some examples, the PTL 401 includes titanium.

In act 402, a coating layer 403 is added to the PTL 401. In some cases, the coating layer 403 may be referred to as an intermediate layer. The coating layer 403 may be made from the same material as the intermediate layer described above with reference to FIG. 4. For example, a less noble element than the catalyst layer 405 may be included in the coating layer 403. Alternatively, the coating layer 403 may include carbon nanotube structures described above with reference to FIG. 4.

In act 404, the coating layer 403 is sintered to densify the coating layer 403, thereby creating a microporous layer. Once sintered or densified, the microporous structures provides a surface for addition of a catalyst layer 405.

In act 406, a catalyst layer 405 is added to a surface of the PTL 401 that has been covered with the coating layer 403. Any of the deposition processes mentioned above may be used to deposit the catalyst layer 405. For example, the catalyst layer 405 may be added using a variety of methods, such as nanomaterial slurry processing, solvent cast, tape casting, sputtering, electrodeposition, CVD, PVD, or ALD. The catalyst layer 405 may include a catalyst configured to facilitate the oxygen evolution reaction on the anode side of the electrolytic cell. In some examples, the catalyst layer 405 includes an iridium or iridium oxide (Ir/IrOx) catalyst. In other examples, the catalyst layer 405 includes platinum. In yet other examples, the catalyst layer 405 includes a combination of Ir/IrOx and platinum. The coating layer 403 advantageously protects the porous structure of the PTL 401 from any effects of the deposition of the catalyst layer 405. Further, the coating layer 403 provides a microporous structure for the addition of the catalyst layer 405.

In some cases, the methods described in FIG. 4 and FIG. 5 may be combined to retain porosities for better water and gas transport. For example, the etching of act 306 may be performed on the PTL 401 coated with the coating layer 403 and the catalyst layer 405.

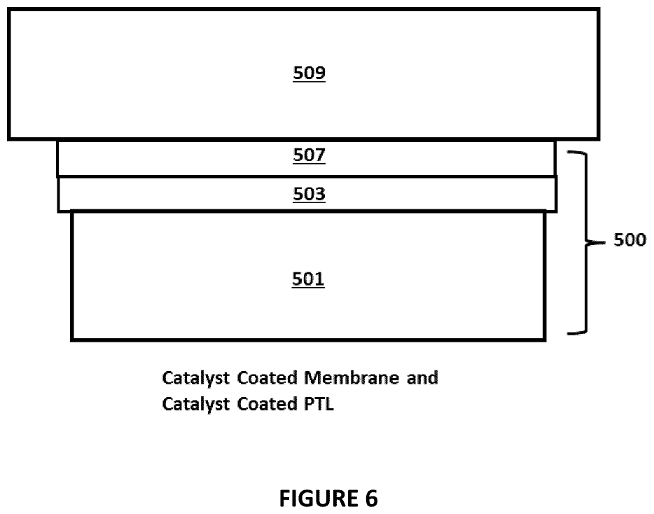

FIG. 6 depicts an example of a coated PTL 500 including a PTL 501 coated with a sacrificial layer 503 and a catalyst layer 507. The coated PTL 500 may be brought into contact with or adjacent to a membrane 509. Both the methods described in the examples of FIG. 4 and FIG. 5 may minimize the roughness factor on the PTL 501 and therefore may be used in conjunction with a solvent cast nanomaterial processing on membranes without risk of the catalyst layer 507 poking or puncturing the membrane 509. By combining the technique of coating the PTL 501 with catalyst the catalyst layer 507 in addition to preparation of the membrane, the number of defects introduced in the cell during assembly of these components may be minimized. By coating the PTL 501 in addition to nanomaterial processing on the membranes, different layers with multiple porosities may be used in the cell for better performance. The different support materials for the catalyst may improve ionic properties such as ionic conductivity, ion diffusion properties, and ion and mass transport rates.

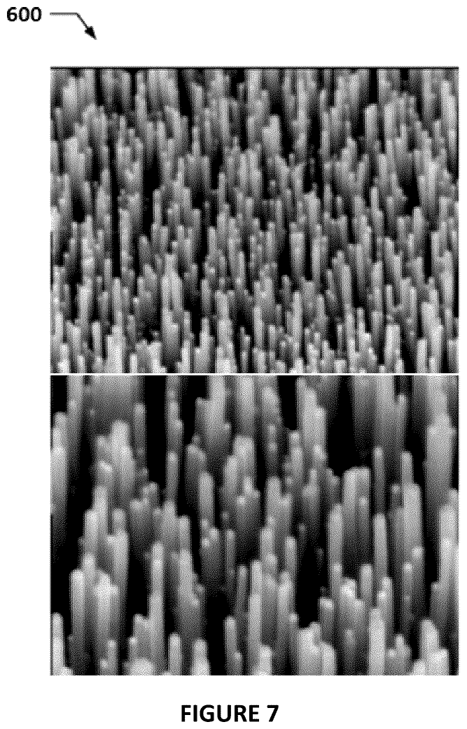

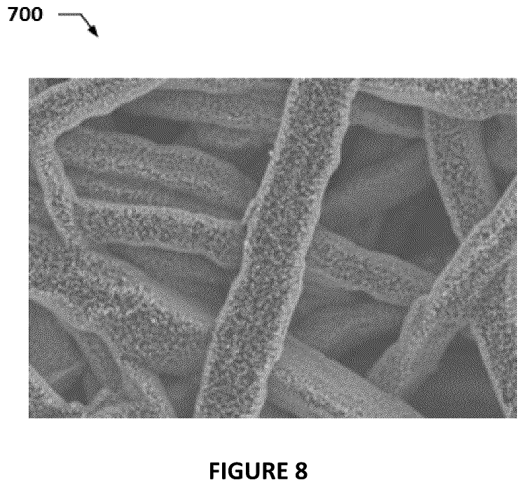

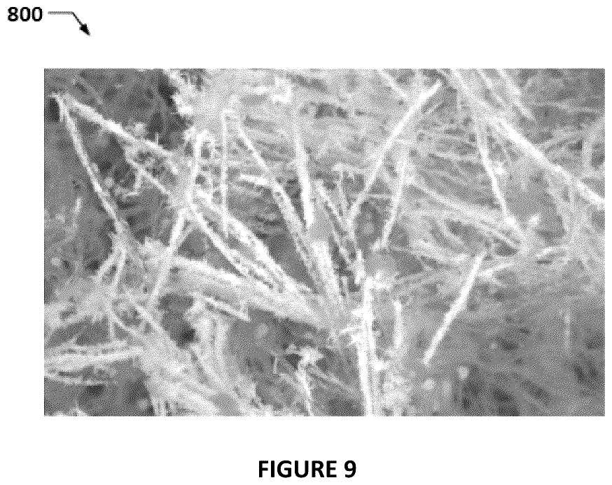

FIG. 7 depicts an example of vertically aligned carbon nanotube structures. FIG. 8 depicts aligned carbon nanotubes deposited on titanium PTL. FIG. 9 depicts aligned nanotubes after electrodeposition of iridium and thermally annealing in 500° C. for 2 hours.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A method of preparing a porous transport layer for an electrochemical cell, the method comprising:
depositing an intermediate layer on a surface of the porous transport layer;
depositing a catalyst layer on an exposed surface of the intermediate layer such that the intermediate layer is positioned between the catalyst layer and the porous transport layer; and
subsequently removing a portion of the intermediate layer,
wherein the catalyst layer and a microporous structure remains on the surface of the porous transport layer.

2. The method of claim 1, wherein the portion of the intermediate layer is removed via etching.

3. The method of claim 1, further comprising:
applying a lithographic mask on the intermediate layer.

4. The method of claim 1, wherein the intermediate layer comprises nickel, cobalt, ion, manganese, an alkali element, a rare earth element, or a combination thereof.

5. The method of claim 1, wherein the intermediate layer comprises carbon nanotube structures.

6. The method of claim 5, wherein the carbon nanotube structures are vertically aligned structures extending in a direction perpendicular from the surface of the porous transport layer.

7. The method of claim 6, wherein the carbon nanotube structures have a diameter in a range of 1-100 nm and a length in a range of 0.1-100 microns.

8. The method of claim 5, wherein the portion of the intermediate layer is removed over time via decomposition in oxygen.

9. The method of claim 1, wherein the catalyst layer comprises iridium, iridium oxide, platinum, or a combination thereof.

10. The method of claim 1, wherein the porous transport layer comprises titanium.

11. The method of claim 1, wherein the catalyst layer is deposited on the surface of the intermediate layer using solvent casting, tape casting, sputtering, electrodeposition, chemical vapor deposition, physical vapor deposition, atomic layer deposition, or a combination thereof.

12. The method of claim 1, further comprising, prior to the depositing of the catalyst layer:
depositing an additional intermediate layer on the porous transport layer, the additional intermediate layer comprising carbon nanotube structures.

13. The method of claim 12, wherein the carbon nanotube structures are vertically aligned structures extending in a direction perpendicular from the surface of the porous transport layer.

14. The method of claim 13, wherein the carbon nanotube structures have a diameter in a range of 1-100 nm and a length in a range of 0.1-100 microns.

15. The method of claim 12, wherein the portion of the additional intermediate layer is removed over time via decomposition in oxygen.

16. The method of claim 1, further comprising:
sintering the intermediate layer to the porous transport layer,
wherein the intermediate layer is a microporous layer.

17. The method of claim 1, further comprising:
adhering a membrane to the catalyst layer.

18.-29. (canceled)
